(19) United States
(12) Patent Application Publication
(10) Pub. No.: US 2026/0221124 A1
(43) Pub. Date: Jul. 30, 2026

(54) PERCUSSION INSTRUMENT STAND

(71) Applicant: HOSHINO GAKKI CO., LTD., Nagoya (JP)

(72) Inventor: Hideyuki MIYAJIMA, Nagoya (JP)

(21) Appl. No.: 19/284,500

(22) Filed: Jul. 29, 2025

(30) Foreign Application Priority Data
Jan. 24, 2025 (JP) 2025-010475

(51) Int. Cl. G10D 13/10

(52) U.S. Cl. CPC G10D 13/28; G10D 13/26

(57) ABSTRACT

A stand includes a first support column, two second support columns extending along the first support column, and two first arms respectively connecting the first support column to the two second support columns. The first support column and the two second support columns are arranged such that line segments connecting a central axis of the first support column and central axes of the two second support columns form a triangle as viewed in the vertical direction. Each of the two first arms is supported to be rotatable about horizontal axes with respect to the first support column and the corresponding second support column. The two second support columns are configured to be deployed and folded with respect to the first support column by rotation of the two first arms.

### CROSS-REFERENCE TO RELATED APPLICATIONS

This application is based upon and claims the benefit of priority from Japanese Patent Application No. 2025-010475, filed on January 24, 2025, the entire contents of which are incorporated herein by reference.

### BACKGROUND

### 1. Field

The present disclosure relates to a percussion instrument stand.

### 2. Description of Related Art

Japanese Laid-Open Patent Publication No. 2014-92588 discloses an electronic drum set including multiple pads and a stand for supporting the pads.

The stand includes a central support column, a left support column, a right support column, a left horizontal frame member, and a right horizontal frame member. The left support column and the right support column are positioned respectively to the left and rearward of and to the right and rearward of the central support column as viewed from of the player. The left horizontal frame member connects the central support column to the left support column, and the right horizontal frame member connects the central support column to the right support column. Various pads are supported by the center support column, the left support column, and the right support column.

The opposite ends of the left horizontal frame member are connected to the central support column and the left support column. One end of the right horizontal frame member is connected to the central support column via a clamp with a handle. The other end of the right horizontal frame member is connected to the right support column. The right horizontal frame member can be rotated about the central support column, which acts as the rotation axis, by loosening the clamp with the handle. The stand is folded by rotating the right horizontal frame member so as to approach the left horizontal frame member.

In the stand described in Japanese Laid-Open Patent Publication No. 2014-92588, when the player deploys the stand, the player rotates the right horizontal frame member away from the left horizontal frame member and then fastens the clamp with a handle. At this time, the player must adjust the rotation angle of the right horizontal frame member to a desired rotation angle. Therefore, when the stand is repeatedly folded and deployed, variations in the positional relationship among the support columns may occur, making it difficult to reproduce the configuration of the stand.

Further, in a stand configured to be folded, it is preferable that the folded stand is not large in size for purposes such as packaging and storage. However, in the stand disclosed in Japanese Laid-Open Patent Publication No. 2014-92588, the distance between the central support column and the left support column, and the distance between the central support column and the right support column remain unchanged before and after folding. This imposes inherent limitations on reducing the size of the stand in the folded state. The left horizontal frame member and the right horizontal frame member may be removed from the respective support columns in order to limit the size of the stand in the folded state. In this case, reassembly becomes time-consuming, and the positional relationship between the support columns may become even more difficult to reproduce.

In view of the above, it is desired to achieve both improvement in reproducibility of the configuration of the stand in the deployed state and reduce the size of the stand in the folded state.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a percussion instrument stand for supporting percussion instruments includes a first support column extending in a vertical direction and installed on an installation surface, two second support columns extending along the first support column and being installed on the installation surface, and two arms respectively connecting the first support column to the two second support columns. The first support column and the two second support columns are arranged such that line segments connecting a central axis of the first support column and respective central axes of the two second support columns form a triangle as viewed in the vertical direction. Each of the two arms is supported to be rotatable about horizontal axes with respect to the first support column and the corresponding second support column. The two second support columns are configured to be deployed and folded with respect to the first support column by rotation of the two arms.

Other features and aspects will be apparent from the following detailed description, the drawings, and the claims.

### BRIEF DESCRIPTION OF THE DRAWINGS

FIG. 1 is a perspective view of an electronic drum set.

FIG. 2 is a front view of a stand of the electronic drum set in a deployed state.

FIG. 3 is a front view of the stand in a folded state.

FIG. 4 is a plan view of the stand shown in FIG. 2.

FIG. 5 is a plan view of the stand shown in FIG. 3.

FIG. 6 is a side view of the stand mainly showing an attachment member.

FIG. 7 is a cross-sectional view of the attachment member shown in FIG. 6.

FIG. 8 is a perspective view of the stand to which support rods are attached.

FIG. 9 is a cross-sectional view of the bracket shown in FIG. 8.

FIG. 10 is a cross-sectional view of the stand mainly showing an attachment portion.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

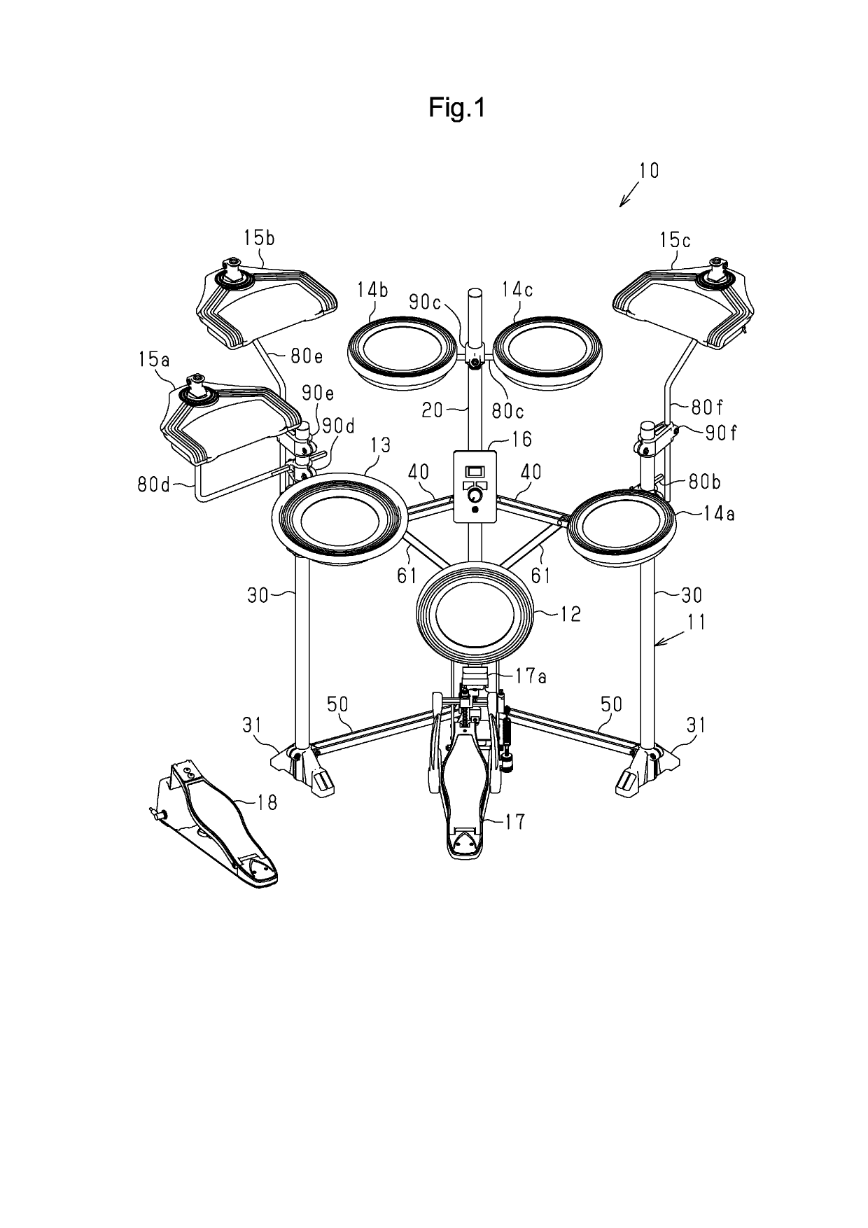

A percussion instrument according to an embodiment will now be described with reference to FIGS. 1 to 10. In the present embodiment, the percussion instrument stand is a stand 11 that supports multiple pads forming an electronic drum set 10.

Overall Configuration of the Electronic Drum Set 10

The electronic drum set 10 includes the stand 11, a bass drum pad 12, a snare drum pad 13, a floor tom pad 14a, a first tom pad 14b, a second tom pad 14c, a hi-hat cymbal pad 15a, and two cymbal pads 15b, 15c. Each pad is an example of a percussion instrument.

The electronic drum set 10 includes a sound source device 16, which produces sounds based on the output signals of vibration sensors provided on the pads. The sound source device 16 is attached to the stand 11. The sound source device 16 is connected to the vibration sensors of the pads by cables (not shown).

The pads other than the bass drum pad 12 are played by the player by striking them with a stick (not shown). The bass drum pad 12 is played with a pedal device 17 including a beater 17a, which swings in response to a stepping operation by the player. The hi-hat cymbal pad 15a produces a different tone when struck depending on the presence or absence of a stepping operation of a hi-hat pedal 18 by the player.

### Configuration of the Stand 11

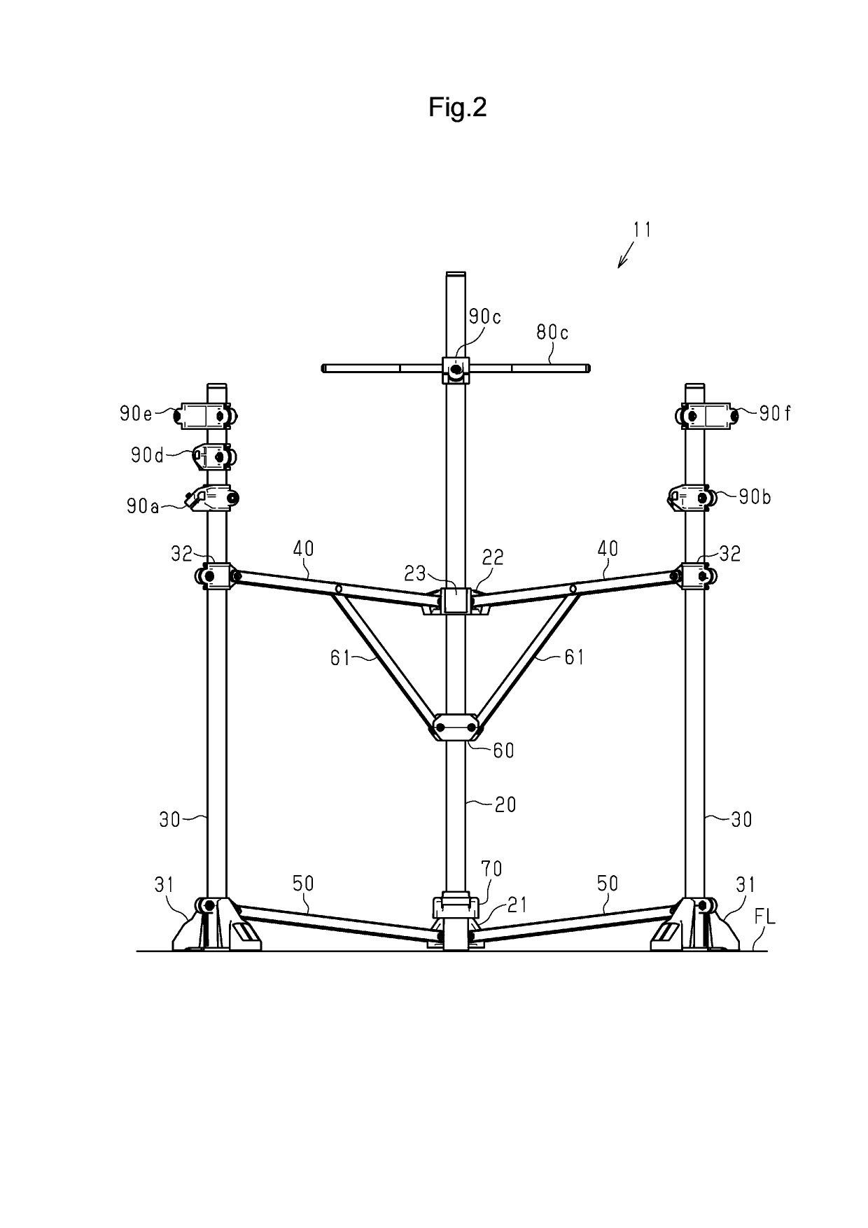

As shown in FIG. 2, the stand 11 includes a first support column 20, two second support columns 30, two first arms 40, and two second arms 50.

The first support column 20 extends linearly in the vertical direction and is installed on an installation surface FL. The first support column 20 includes a first leg portion 21, which is provided at a lower end of the first support column 20 and comes into contact with the installation surface FL.

Each of the second support columns 30 extends linearly in the vertical direction along the first support column 20 and is installed on the installation surface FL. Each of the second support columns 30 includes a second leg portion 31, which is provided at a lower end of the second support column 30 and comes into contact with the installation surface FL.

The first support column 20 and the two second support columns 30 extend in parallel to each other. The vertical length of each second support column 30 is shorter than the vertical length of the first support column 20.

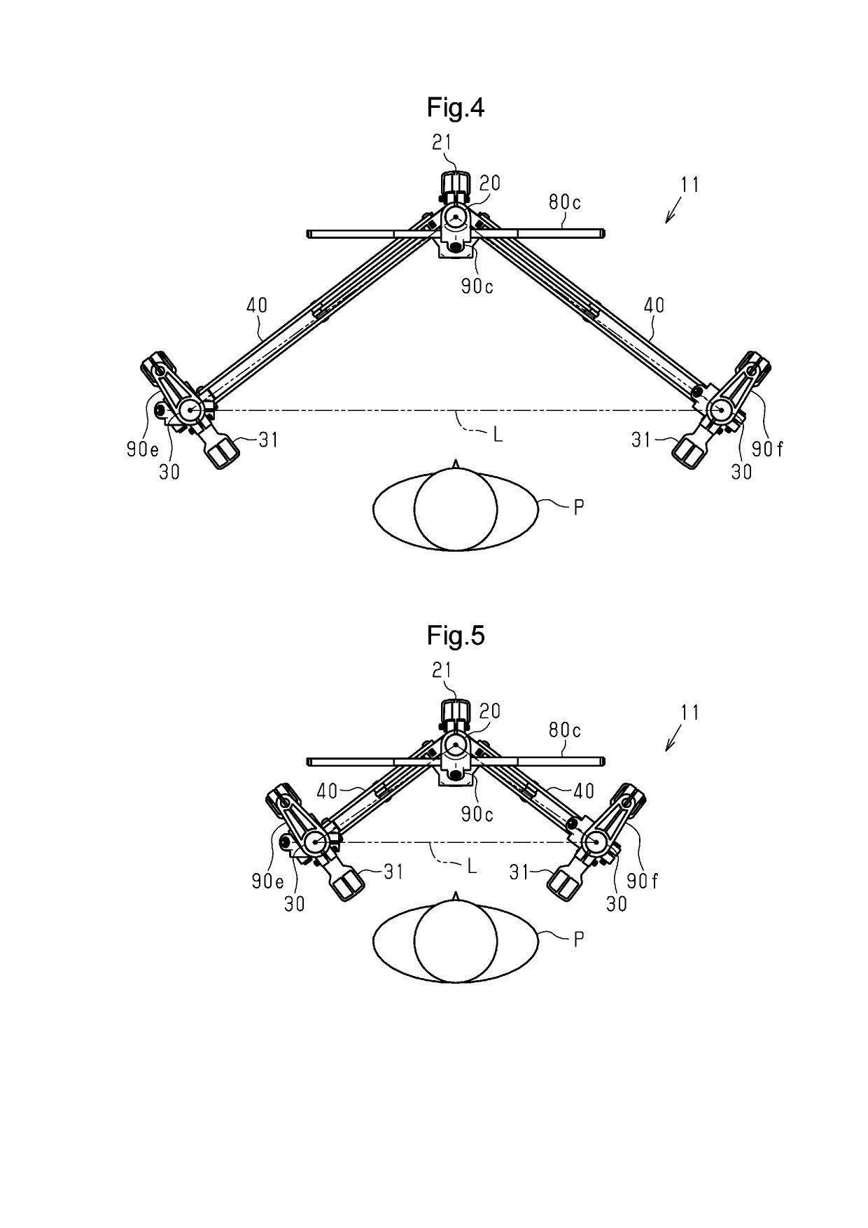

As shown in FIG. 4, the first support column 20 is disposed between the two second support columns 30 and rearward of the two second support columns 30 as viewed from the player P. The first support column 20 and the two second support columns 30 are arranged such that line segments L connecting a central axis of the first support column 20 and central axes of the respective second support columns 30 form a triangle when viewed in the vertical direction. The line segments L of the present embodiment form an isosceles triangle.

As shown in FIG. 2, the first support column 20 includes a first support portion 22, which rotatably supports one end of each first arm 40. The first support portion 22 is provided in a section between the upper end and the lower end of the first support column 20. The first support portion 22 is an example of a support portion.

Each of the second support columns 30 has a second support portion 32, which rotatably supports the other end of the corresponding first arm 40. The second support portion 32 is provided in a section between the upper end and the lower end of the second support column 30.

The two first arms 40 connect the first support column 20 to the two second support columns 30, respectively. Each of the first arms 40 extends linearly. One end of each first arm 40 is supported to be rotatable with respect to the first support portion 22 of the first support column 20 about an axis extending in the horizontal direction. The other end of each of the first arms 40 is rotatably supported by the second support portion 32 of the corresponding second support column 30 about an axis extending in the horizontal direction.

The two second arms 50 respectively connect the first support column 20 to the two second support columns 30 at positions different from the two first arms 40 in the length direction of the first support column 20. In the present embodiment, the two first arms 40 respectively connect the first support column 20 to the two second support columns 30 at positions above the two second arms 50. Each of the second arms 50 extends linearly. The length of each second arm 50 is the same as the length of each first arm 40. One end of each second arm 50 is supported to be rotatable with respect to the first leg portion 21 of the first support column 20 about an axis extending in the horizontal direction. The other end of each second arm 50 is supported to be rotatable with respect to the second leg portion 31 of the corresponding second support column 30 about an axis extending in the horizontal direction.

The two first arms 40 and the two second arms 50 extend parallel to each other. As described above, the first support column 20 and the two second support columns 30 extend parallel to each other. Accordingly, the stand 11 forms four-bar linkage mechanisms, each of which includes the first support column 20, one of the second support columns 30, and the corresponding first arm 40 and the corresponding second arm 50, which connect the first support column 20 to the second support column 30.

The stand 11 includes a slider 60 and two stays 61.

The slider 60 is configured to be slid in the length direction of the first support column 20. The slider 60 slides on a section of the first support column 20 between the first leg portion 21 and the first support portion 22.

The two stays 61 connect the slider 60 to the two first arms 40, respectively. One end of each stay 61 is supported to be rotatable with respect to the slider 60 about an axis extending in the horizontal direction. The other end of each stay 61 is supported to be rotatable with respect to the corresponding first arm 40 about an axis extending in the horizontal direction.

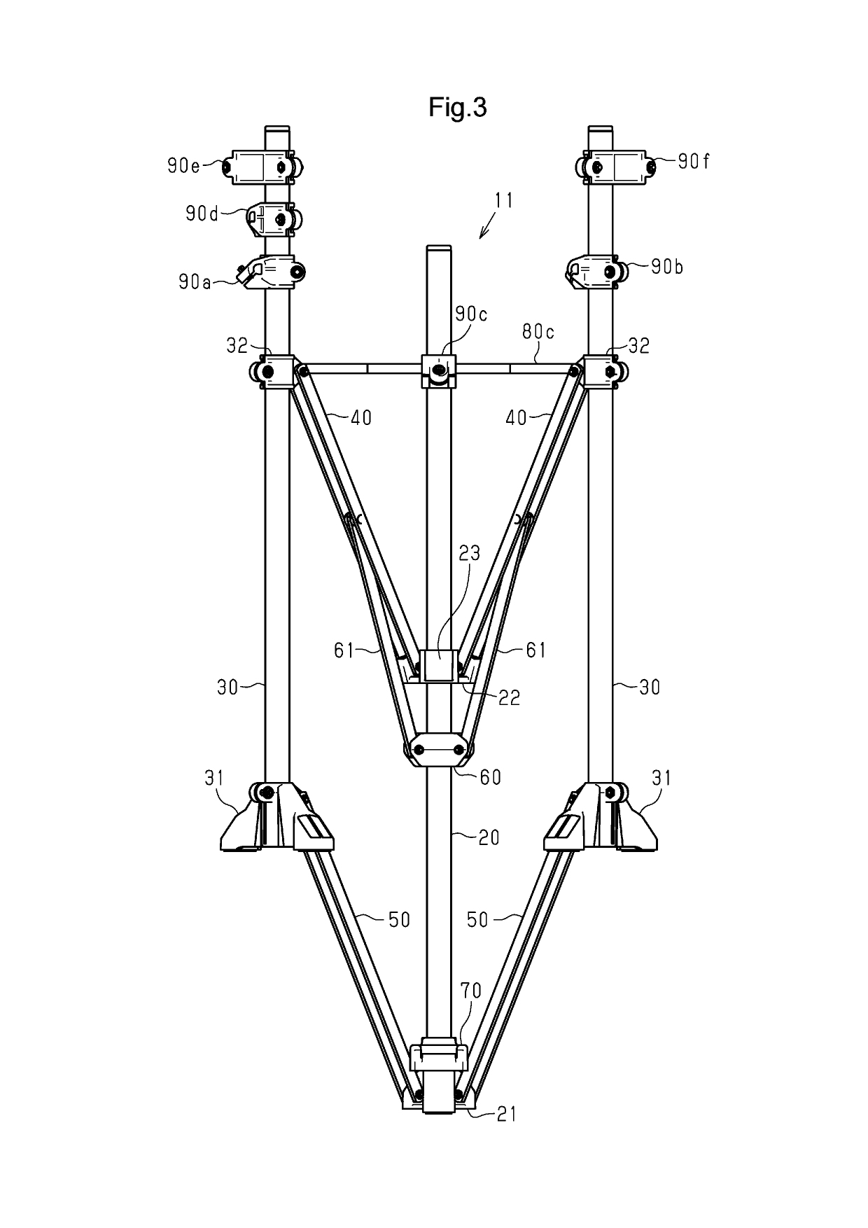

As shown in FIGS. 2 and 3, the two second support columns 30 are configured to be deployed and folded with respect to the first support column 20 by the two first arms 40 rotating in conjunction with the sliding of the slider 60 on the first support column 20. When the slider 60 moves downward from the state in which the two second support columns 30 are folded, the two second support columns 30 are deployed so as to separate from the first support column 20. When the slider 60 moves upward from the state in which the two second support columns 30 are deployed, the two second support columns 30 are folded so as to approach the first support column 20. In a state in which the two second support columns 30 are folded with respect to the first support column 20, the upper end of each second support column 30 is positioned above the upper end of the first support column 20, and the lower end of each second support column 30 is positioned above the lower end of the first support column 20. When the two second support columns 30 are deployed or folded with respect to the first support column 20, the two second support columns 30 move while maintaining an orientation parallel to the first support column 20.

The slider 60 is configured to be fixed to the first support column 20 at an arbitrary position in the length direction of the first support column 20 by, for example, a clamping mechanism. The slider 60 is allowed to slide with respect to the first support column 20 by weakening the clamping force of the clamping mechanism.

When the slider 60 is fixed to the first support column 20 in a state in which the two second support columns 30 are deployed or folded, the movement of the two second support columns 30 with respect to the first support column 20 is restricted. As a result, the configuration of the stand 11 is readily maintained in the deployed or folded state of the two second support columns 30. The clamping mechanism includes, for example, a configuration similar to that of two first clamping portions 91 and a first fastening portion 92, which will be described below.

As shown in FIGS. 4 and 5, when the two second support columns 30 are deployed or folded with respect to the first support column 20, the shape of the triangle formed, as viewed in the vertical direction, by the line segments L connecting the central axis of the first support column 20 and the central axes of the second support columns 30 does not change, but the size of the triangle changes. In other words, when the two second support columns 30 are deployed or folded with respect to the first support column 20, the opening angle of the two first arms 40 and the opening angle of the two second arms 50 do not change when viewed in the vertical direction.

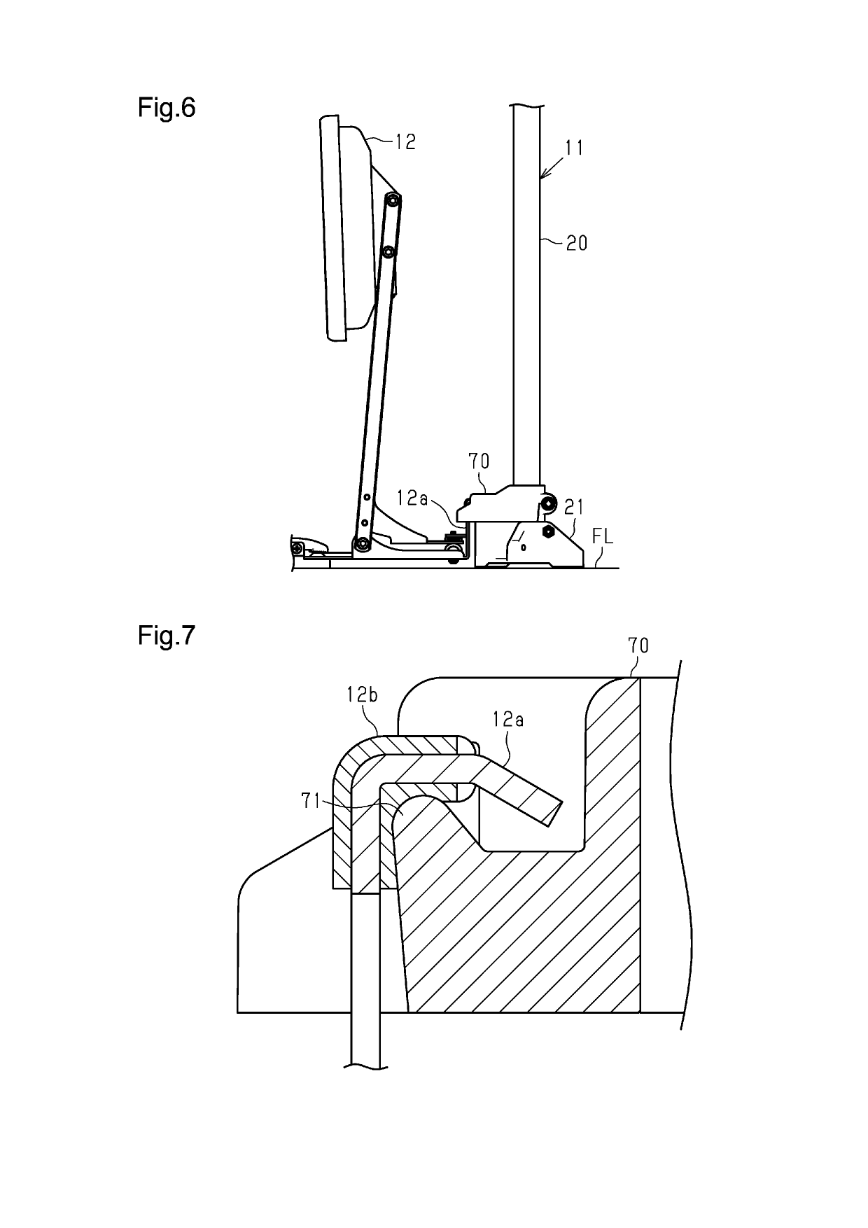

As shown in FIG. 6, the stand 11 includes an attachment member 70, to which the bass drum pad 12 is attached. The attachment member 70 is attached to the first support column 20 at a position above the first leg portion 21.

As shown in FIG. 7, the attachment member 70 is configured such that a hook 12a extending upward from the lower portion of the bass drum pad 12 can be attached to the attachment member 70. The attachment member 70 has a projection 71 for supporting the tip portion of the hook 12a from below. The bass drum pad 12 is attached to the attachment member 70 by engaging the hook 12a with the projection 71 from above. A felt member 12b is attached to a portion of the hook 12a that is in contact with the attachment member 70.

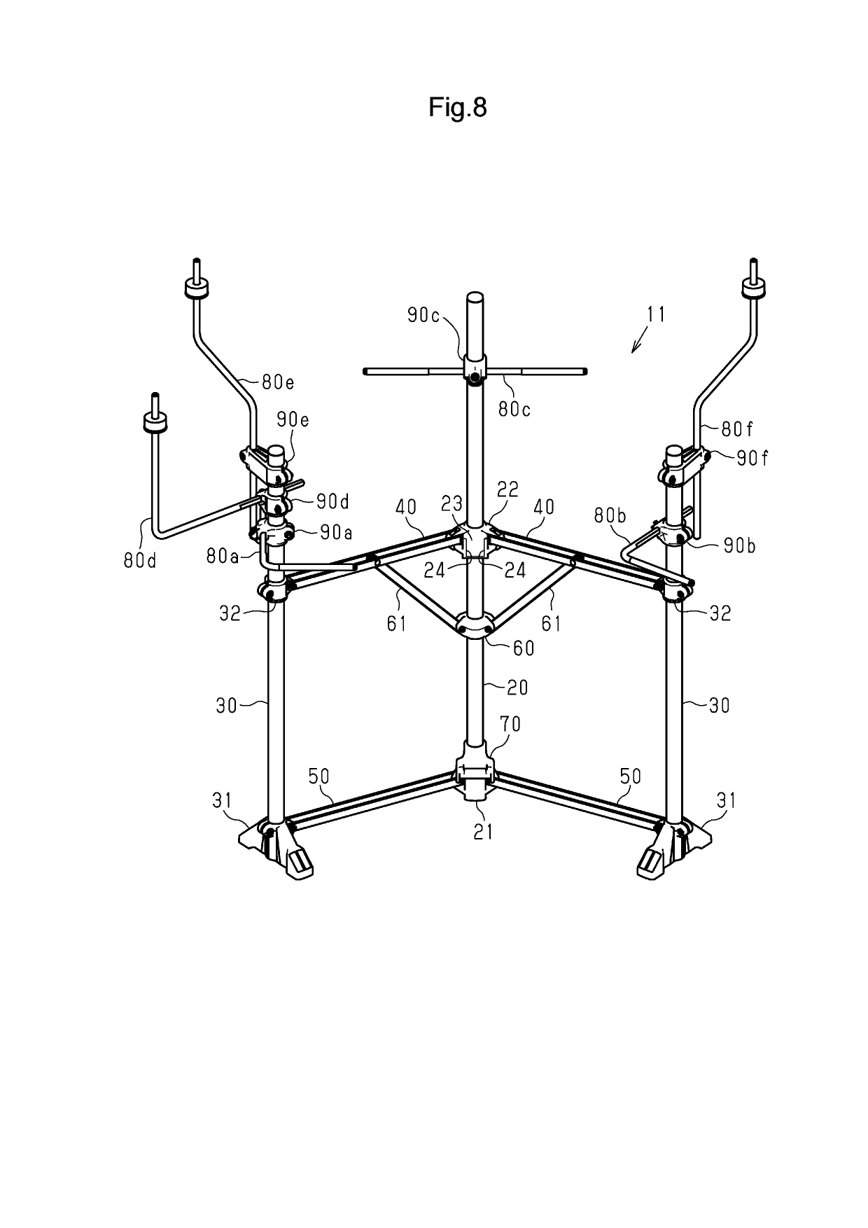

As shown in FIG. 8, the stand 11 includes six support rods 80a, 80b, 80c, 80d, 80e, and 80f and six brackets 90a, 90b, 90c, 90d, 90e, and 90f, which respectively hold the six support rods 80a, 80b, 80c, 80d, 80e, and 80f.

As shown in FIGS. 1 and 8, the support rod 80a supports the snare drum pad 13. The support rod 80b supports the floor tom pad 14a. The support rod 80c supports the first tom pad 14b and the second tom pad 14c. The support rod 80d supports the hi-hat cymbal pad 15a. The support rod 80e supports the cymbal pad 15b. The support rod 80f supports the cymbal pad 15c.

As shown in FIG. 8, the bracket 90a is attached to the second support column 30 on the left side as viewed from the player, and holds the support rod 80a. The bracket 90a is attached to a section of the left second support column 30 above the second support portion 32.

The bracket 90b is attached to the second support column 30 on the right side as viewed from the player, and holds the support rod 80b. The bracket 90b is attached to a section of the right second support column 30 above the second support portion 32.

The bracket 90c is attached to the first support column 20 and holds the support rod 80c. The bracket 90c is attached to a section of the first support column 20 above the first support portion 22.

The bracket 90d is attached to the second support column 30 on the left side as viewed from the player, and holds the support rod 80d. The bracket 90d is attached to a section of the left second support column 30 above the bracket 90a.

The bracket 90e is attached to the second support column 30 on the left side as viewed from the player, and holds the support rod 80e. The bracket 90e is attached to a section of the left second support column 30 above the bracket 90d.

The bracket 90f is attached to the second support column 30 on the right side as viewed from the player, and holds the support rod 80f. The bracket 90f is attached to a section of the right second support column 30 above the bracket 90b.

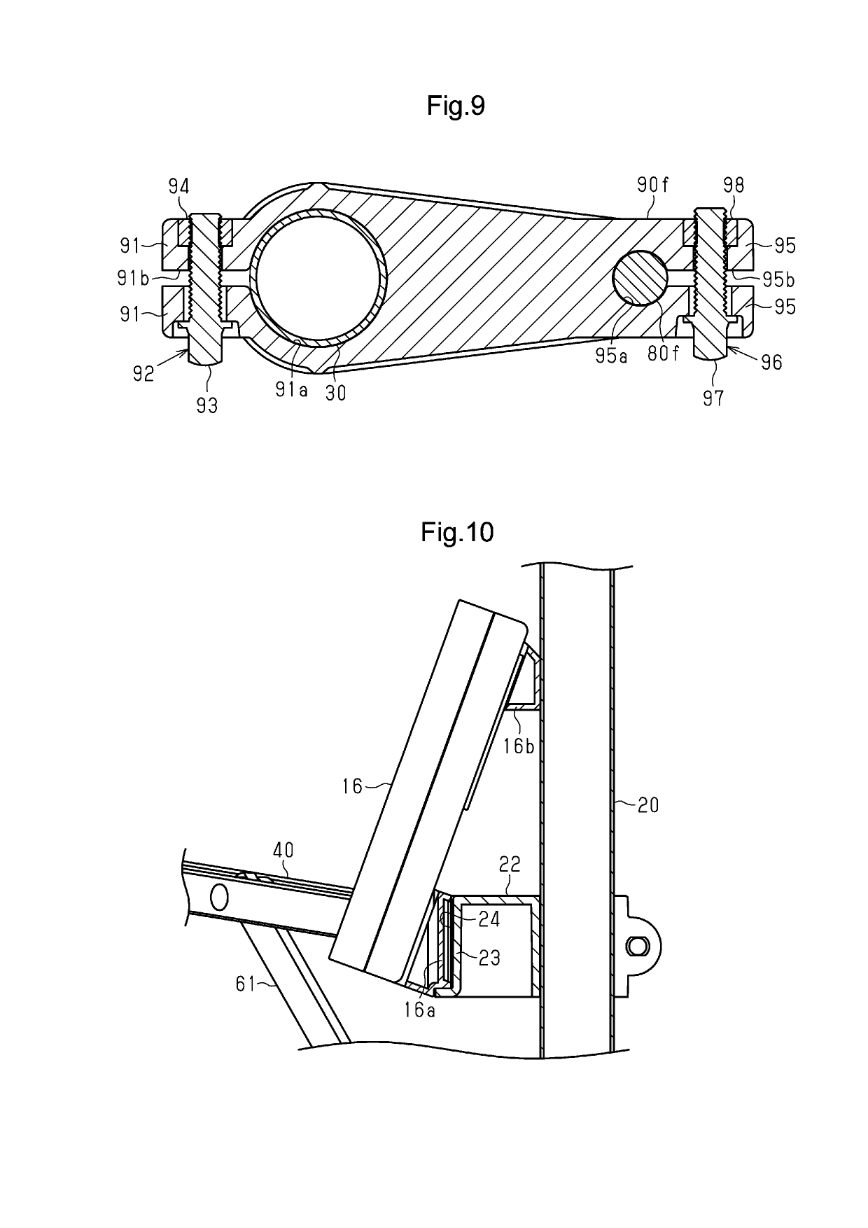

As shown in FIG. 9, the bracket 90f connects the second support column 30 to the support rod 80f. The bracket 90f includes two first clamping portions 91 for clamping the second support column 30, and a first fastening portion 92 for fastening the two first clamping portions 91. The two first clamping portions 91 form a circular first holding hole 91a for holding the second support column 30 and a first slit 91b continuous with the first holding hole 91a. The first fastening portion 92 includes a first bolt 93, which extends through the two first clamping portions 91, and a first nut 94, which is embedded in one of the two first clamping portions 91. The first fastening portion 92 can change the fastening amount of the two first clamping portions 91 on the second support column 30 by changing the threaded amount of the first bolt 93 into the first nut 94. By loosening the fastening force of the two first clamping portions 91 on the second support column 30, the bracket 90f becomes slidable along the length direction of the second support column 30 and rotatable about the second support column 30. Accordingly, the bracket 90f is configured such that its attaching position on the second support column 30 is adjustable.

The bracket 90f can be removed from the second support column 30 by moving the bracket 90f upward with respect to the second support column 30 until the upper end of the second support column 30 exits the first holding hole 91a. Conversely, the bracket 90f can be attached to the second support column 30 by inserting the upper end of the second support column 30 into the first holding hole 91a. Accordingly, the bracket 90f is configured to be attached to and detached from the second support column 30 via the upper end of the second support column 30.

The bracket 90f includes two second clamping portions 95 for clamping the support rod 80f, and a second fastening portion 96 for fastening the two second clamping portions 95. The two second clamping portions 95 form a circular second holding hole 95a for holding the support rod 80f and a second slit 95b continuous with the second holding hole 95a. The central axis of the second holding hole 95a extends in parallel to the central axis of the first holding hole 91a. The second fastening portion 96 includes a second bolt 97, which extends through the two second clamping portions 95, and a second nut 98, which is embedded in one of the two second clamping portions 95. The second fastening portion 96 can change the fastening amount of the two second clamping portions 95 on the support rod 80f by changing the threaded amount of the second bolt 97 into the second nut 98. By loosening the fastening force of the two second clamping portions 95 on the support rod 80f, the support rod 80f becomes slidable along the length direction of the support rod 80f with respect to the bracket 90f and rotatable about the bracket 90f. Therefore, the bracket 90f is configured such that the holding position of the support rod 80f is adjustable.

Similarly to the bracket 90f, the brackets 90a to 90f each include two first clamping portions 91, a first fastening portion 92, two second clamping portions 95, and a second fastening portion 96. Accordingly, similarly to the bracket 90f, the brackets 90a to 90e are configured to be attached to and detached from the first support column 20 and the second support columns 30 via the upper ends of the first support column 20 and the second support columns 30. In each the brackets 90a to 90d, the central axis of the first holding hole 91a and the central axis of the second holding hole 95a are orthogonal to each other. The second clamping portions 95 of the brackets 90a to 90d hold horizontally extending sections of the support rods 80a to 80d. The second clamping portions 95 of the brackets 90e and 90f hold vertically extending sections of the support rods 80e and 80f.

As shown in FIGS. 8 and 10, the first support portion 22 includes an attachment portion 23 to which the sound source device 16 can be attached. The attachment portion 23 includes two vertical grooves 24, which are opened to face each other in the direction in which the two second support columns 30 are arranged. The upper end of each groove 24 opens upward, while the lower end thereof is closed.

As shown in FIG. 10, the sound source device 16 includes a housing having a vertically elongated rectangular parallelepiped shape. A plate-shaped slide portion 16a, which is configured to be inserted into the two grooves 24 from above, is provided on the back surface of the lower portion of the housing. The sound source device 16 is attached to the attachment portion 23 by inserting the slide portion 16a into the two grooves 24.

The housing includes a support protrusion 16b on the back surface of the upper portion. The support protrusion 16b maintains the orientation of the sound source device 16 by contacting the first support column 20.

### Operation of the Present Embodiment

As shown in FIGS. 2 to 5, when the two second support columns 30 are deployed or folded with respect to the first support column 20, each of the first arms 40 and each of the second arms 50 rotate about horizontal axes with respect to the first support column 20 and the second support columns 30. This prevents the opening angles of the two first arms 40 and the two second arms 50 as viewed in the vertical direction from being changed before and after the two second supports 30 are deployed. Accordingly, it is possible to suppress variations in the positions of the two second support columns 30 with respect to the first support column 20 after the two second support columns 30 are deployed. As a result, even when the two second support columns 30 are repeatedly deployed, the shape and the size of the triangle formed, as viewed in the vertical direction, by the line segments L connecting the central axis of the first support column 20 and the central axes of the second support columns 30 are unlikely to change.

In addition, with the above-described configuration, the two second support columns 30 are folded with respect to the first support column 20 by rotation of the two first arms 40 and the two second arms 50. Since each of the second support columns 30 is supported to be rotatable with respect to the corresponding first arm 40 and the corresponding second arm 50, the stand 11 can be folded such that the two second support columns 30 extend along the first support column 20.

### Advantages of the Present Embodiment

(1) The first support column 20 and the two second support columns 30 are arranged such that the line segments L connecting the central axis of the first support column 20 and the central axes of the respective second support columns 30 form a triangle when viewed in the vertical direction. Each first arm 40 is supported to be rotatable about horizontal axes with respect to the first support column 20 and the corresponding second support column 30. The two second support columns 30 are configured to be deployed and folded with respect to the first support column 20 by rotation of the two first arms 40.

With this configuration, it is possible to achieve both improvement in reproducibility of the configuration of the stand 11 in the deployed state and a decrease in the size of the stand 11 in the folded state.

(2) Each second arm 50 is supported to be rotatable about horizontal axes with respect to the first support column 20 and the corresponding second support column 30.

With this configuration, each of the second support columns 30 is connected to the first support column 20 by the corresponding first arm 40 and the corresponding second arm 50. This readily stabilizes the orientations of the two second support columns 30. Therefore, the reproducibility of the configuration of the stand 11 in the deployed state is improved.

(3) The first support column 20 and the two second support columns 30 extend in parallel to each other. The two first arms 40 and the two second arms 50 extend parallel to each other.

With this configuration, when the two first arms 40 and the two second arms 50 rotate with respect to the first support column 20, the two second support columns 30 are deployed or folded while maintaining the orientations parallel to the first support column 20. Therefore, the reproducibility of the configuration of the stand 11 in the deployed state is improved.

(4) The two second support columns 30 are configured to be deployed and folded with respect to the first support column 20 in conjunction with the sliding of the slider 60.

With this configuration, by sliding the slider 60 in the length direction of the first support column 20, the two second support columns 30 are simultaneously deployed or folded with respect to the first support column 20. Therefore, the two second support columns 30 can be readily deployed and folded.

(5) The two first arms 40 respectively connect the first support column 20 to the two second support columns 30 at positions above the two second arms 50. The two stays 61 connect the slider 60 to the two first arms 40, respectively.

With this configuration, the first arms 40, which are connected to the first support column 20 and the second support columns 30 at positions above the second arms 50, are supported by the stays 61. Therefore, each stay 61 receives the load of the pad supported by the corresponding second support column 30 at a higher position than in a case in which the stay 61 is connected to the second arm 50. Accordingly, the stability of the stand 11 is improved.

(6) The first support column 20 is disposed rearward of the two second support columns 30 as viewed from the player.

With this configuration, as shown in FIG. 1, a space surrounded by the first support column 20 and the two second support columns 30 is formed around a foot of the player. Therefore, the space can be utilized as a space for disposing the bass drum pad 12.

(7) The vertical length of each second support column 30 is shorter than the vertical length of the first support column 20.

With this configuration, when the player plays the first tom pad 14b and the second tom pad 14c, which are supported by the first support column 20, the second support columns 30 are unlikely to interfere with the player’s playing.

(8) The stand 11 includes an attachment member 70, to which the bass drum pad 12 is attached.

With this configuration, the attachment of the bass drum pad 12 to the attachment member 70 restricts movement of the bass drum pad 12 toward the first support column 20 caused by striking impact when the bass drum pad 12 is struck. Thus, the position of the bass drum pad 12 relative to the other pads is less likely to change. Also, this eliminates the need for an additional structure for fixing the bass drum pad 12 to the installation surface FL.

(9) Each of the brackets 90a to 90f is configured to be attached to and detached from the first support column 20 or the corresponding second support column 30 via the upper end of the first support column 20 or the second support column 30.

For example, when the brackets 90a to 90f are attached to one of the first arms 40, since the end of the first arm 40 is connected to the first support column 20 or the corresponding second support column 30, it is difficult to attach and detach the brackets 90a to 90f via the end of the first arm 40.

In this regard, with the above-described configuration, the brackets 90a to 90f can be attached to and detached from the first support column 20 and the second support columns 30 via the upper ends of the first support column 20 and the second support columns 30. Therefore, the brackets 90a to 90f can be attached and detached with ease. As a result, attachment and detachment of pads to and from the stand 11 can be performed smoothly.

(10) The first support portion 22 includes the attachment portion 23, to which the sound source device 16 can be attached.

With this configuration, no additional component is required to attach the sound source device 16 to the stand 11 separately from the first support portion 22. This limits the number of components of the stand 11.

### Modifications

The above-described embodiment may be modified as follows. The above-described embodiment and the following modifications can be combined if the combined modifications remain technically consistent with each other.

The first support portion 22 does not necessarily need to include the attachment portion 23. In this case, the stand 11 may include a connecting member that connects the first support column 20 to the sound source device 16, separately from the first support portion 22.

The brackets 90a to 90f may be fixed to the first support column 20 or the second support columns 30 in a non-removable manner.

Each pad may be directly fixed to the first support column 20 or the corresponding second support column 30.

The stand 11 does not necessarily need to include the attachment member 70. In this case, the stand 11 and the bass drum pad 12 may be installed on the installation surface FL while being separated from each other.

The vertical length of each second support column 30 may be greater than or equal to the vertical length of the first support column 20.

The first support column 20 may be disposed frontward of the two second support columns 30 as viewed from the player.

The two stays 61 may connect the slider 60 to the two second arms 50, respectively. In this case, each stay 61 is supported to be rotatable about horizontal axes with respect to the slider 60 and the corresponding second arm 50.

The stand 11 may include two sliders 60 on which the two stays 61 are separately supported.

The stand 11 does not necessarily need to include the slider 60 and the two stays 61. In this case, it is preferable for the player to deploy or fold the two second support columns 30 separately with respect to the first support column 20.

The stand 11 does not necessarily need to include the slider 60, the two stays 61, and the two second arms 50. In other words, each second support column 30 may be connected to the first support column 20 only by the first arm 40. In this case, it is preferable for the player to adjust the degree of parallelism of each second support column 30 relative to the first support column 20 during both deploying and folding of the two second arms 50.

Each of the second support columns 30 does not necessarily need to extend strictly in parallel to the first support column 20, and may extend in a slightly inclined orientation.

The vertical lengths of the two second support columns 30 may be different from each other.

The first support column 20 and each of the second support columns 30 may be configured to be extended and retracted in the vertical direction. The first support column 20 and each of the second support columns 30 may include, for example, a telescopic mechanism in which multiple pipes having different diameters are slidably disposed on the same axis.

The lengths of the two first arms 40 may be different from each other. The lengths of the two second arms 50 may be different from each other. The lengths of the two stays 61 may be different from each other. In this case, the triangle formed by the line segments L connecting the central axis of the first support column 20 and the central axes of the second support columns 30 is not required to be an isosceles triangle.

The stand 11 may include three or more second support columns 30 configured to be deployed and folded with respect to the first support column 20.

The stand 11 may include a third support column configured to be deployed and folded with respect to at least one of the two second support columns 30.

The stand 11 can also be employed as a stand that supports an acoustic drum or a stand that supports a practice pad that does not include a vibration sensor. In addition, the stand 11 may be employed as a stand for supporting a percussion instrument other than a drum. Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A percussion instrument stand for supporting percussion instruments, comprising:
a first support column extending in a vertical direction and installed on an installation surface;
two second support columns extending along the first support column and being installed on the installation surface; and
two arms respectively connecting the first support column to the two second support columns, wherein
the first support column and the two second support columns are arranged such that line segments connecting a central axis of the first support column and respective central axes of the two second support columns form a triangle as viewed in the vertical direction,
each of the two arms is supported to be rotatable about horizontal axes with respect to the first support column and the corresponding second support column, and
the two second support columns are configured to be deployed and folded with respect to the first support column by rotation of the two arms.

2. The percussion instrument stand according to claim 1, wherein
the arms are first arms,
the percussion instrument stand further comprises two second arms, the two second arms respectively connecting the first support column to the two second support columns at positions different from the two first arms in the length direction of the first support column, and the two second arms extending along the first arms, and
each of the two second arms is supported to be rotatable about horizontal axes with respect to the first support column and the corresponding second support column.

3. The percussion instrument stand according to claim 2, wherein
the first support column and the two second support columns extend in parallel to each other,
the two first arms and the two second arms extend in parallel to each other.

4. The percussion instrument stand according to claim 2, further comprising:
a slider configured to be slid in the length direction of the first support column; and
two stays respectively connecting the slider to the two first arms or to the two second arms, wherein
each of the two stays is supported to be rotatable about horizontal axes with respect to the slider and the corresponding first arm or the corresponding second arm, and
the two second support columns are configured to be deployed and folded with respect to the first support column in conjunction with sliding of the slider.

5. The percussion instrument stand according to claim 4, wherein
the two first arms respectively connect the first support column to the two second support columns at positions above the two second arms, and
the two stays respectively connect the slider to the two first arms.

6. The percussion instrument stand according to claim 1, wherein the first support column is disposed rearward of the two second support columns as viewed from a player of the percussion instruments.

7. The percussion instrument stand according to claim 6, wherein a vertical length of each of the two second support columns is shorter than a vertical length of the first support column.

8. The percussion instrument stand according to claim 6, further comprising an attachment member that is attached to the first support column, wherein a bass drum pad that is one of the percussion instruments is attached to the attachment member.

9. The percussion instrument stand according to claim 1, further comprising:
a support rod supporting at least one of the percussion instruments; and
a bracket attached to one of the first support column and the two second support columns and configured to hold the support rod,
wherein the bracket is configured to be attached to and detached from the one of the support columns via an upper end of the one of support columns.

10. The percussion instrument stand according to claim 1, wherein
the first support column includes a support portion that rotatably supports the two arms, and
the support portion includes an attachment portion configured to allow for attachment of a sound source device that produces sound based on an output signal of a vibration sensor provided on at least one of the percussion instruments.
